(19) United States
(12) Patent Application Publication
(10) Pub. No.: US 2006/0136254 A1
(43) Pub. Date: Jun. 22, 2006

(54) System and method for dispatching transportation to persons who want transportation

(76) Inventor: Mark Greenstein, Bethesda, MD (US)

Correspondence Address: BACON & THOMAS, PLLC, 625 SLATERS LANE, FOURTH FLOOR, ALEXANDRIA, VA, 22314, US

(21) Appl. No.: 11/286,369

(22) Filed: Nov. 25, 2005

Related U.S. Application Data
(60) Provisional application No. 60/630,332, filed on Nov. 24, 2004.

(51) Int. Cl. G06Q 99/00

(52) U.S. Cl. 705/1

(57) ABSTRACT

A system and method for providing for the computer-implemented matching of persons who provide transportation and those who purchase such services, using the position of each party and possibly incorporating variable pricing that takes into consideration supply and demand and traffic.

### FIELD OF THE INVENTION

The field of matching persons who need services with those who want services has been greatly impacted by technology. This has enabled persons to purchase and sell services with greater efficiency and immediacy. However, the field of transportation has not fully taken advantage of the available technology.

### BACKGROUND OF THE INVENTION

Persons in need of transportation services either communicate with persons who provide such services, typically by telephone, or in the case of taxicabs may simply take the chance of going into the street to attempt to hail a taxi or go to a taxi stand. This involves uncertainty and inefficiency since persons who want such services have no certainty that such services will be available, yet must expend time in determining their availability. Further, sometimes persons may be provided with incorrect information about availability, either due to an honest error or because of a desire not to lose the fare because an accurate estimate of the time it will take to arrive could discourage the customer. Persons who sell such services are required to expend resources paying persons to answer inquiries and communicate with drivers. They also must frequently, particularly in the case of taxi drivers, deal with anonymous persons with an increase in risk of becoming crime victims, or not being paid for the services that have been provided. Finally, such a system in not flexible in that it does not easily permit flexibility in setting prices that take account of periods during which there is a relative abundance or shortage of available transportation services.

A possible solution to this problem includes providing a data processing system that relies on input concerning the location of the transportation and the location of persons who want such services. The location could be provided, in whole or part by devices carried by or in the transportation or by persons who want such services, such as by Global Positioning System (“GPS”), or by the internet or by set instructions. In this connection, many mobile telephones are expected to have such devices in the near future. Such a system could also set prices, for example by determining the availability of services relative to demand. Such services could be provided automatically per standing instructions and/or could provide the ability to modify such instructions.

### SUMMARY OF THE INVENTION

The current disclosure addresses the problem resulting from the fact that currently, persons (including legal persons) order transportation services in a sub-optimal manner. Currently, persons may order such services on a “hit or miss” basis, for example attempting to hail a taxi on the street. This is inefficient since an available taxi could be very close but not on the street on which a customer is standing. In the alternative, a customer may call a dispatcher, who, when they become available, may check to determine available transportation, check with the operators, and then check with the customer to advise them of the availability and see if it is acceptable. This takes time and is further disadvantaged by the fact that there may be an incentive to exaggerate how fast transportation will come in order not to lose the customer. Further errors and inconsistencies may occur due to operator error and/or differences between operators.

The system of the present disclosure permits a more immediate and uniform response to customers who want transportation services.
1. The systems and methods of the present disclosure may automatically dispatch transportation services based on criteria that have previously been agreed to.
2. Such criteria can include the type of transportation (e.g., a Lincoln Town Car), as well as the anticipated time of arrival (e.g., within 5 minutes), and the price of the service.
3. The systems and methods of the present disclosure may take into account the location of the transportation and that of that must be transported (e.g. a passenger), and may also incorporate consideration of traffic conditions (for example by an analysis of signal sent by mobile phones or personal data assistants) in determining an estimated arrival time.
4. The systems and methods of the present disclosure may take into account the location of the transportation as well as that which will be transported can be determined by a variety of means included GPS as well as by preset instructions (e.g., pick me up at Madison Avenue and 57^{th} Street when you hear from me via internet after 6 PM on weekdays).
5. The systems and methods of the present disclosure may provide feedback to persons who order transportation concerning the estimated time or arrival. In the event that the availability does not meet previously determined criteria, the customer can be provided with alternatives which, in some cases can be simply accepted or not with one or more actions such as responding yes or no to a text message on a mobile telephone.
6. Similarly, the customer can offer given criteria (such as amount he or she is willing to pay) that can then be accepted or not by persons who provide that type of service.
7. The customer can agree to a lower priority of service (e.g., the customer can be “bumped” by a higher priority customer) in exchange for a lower fare or other consideration.
8. Such criteria can incorporate the estimated or actual time that it will take the transportation to arrive at the initial pickup point.
9. The systems and methods of the present disclosure can efficiently identify the person who orders and provides the service, and store this information, which may make it safer for both parties and decreased the likelihood of poor behavior.
10. The systems and methods of the present disclosure can provide for electronic payment from a variety of sources, such as through the phone company, which can be automatically calculated based on criteria such as that which was agreed to or by other criteria such as that provided by the monitoring devices such as GPS.
11. The system and method of the present disclosure can provide a means for easy communication between the person who provides the services (e.g., a taxi driver) and the person who receives the services.
12. The system and method of the present disclosure can provide for a more or less independent third party or third party criteria to monitor the elements and algorithms used in the system to assure customers that they are provided with realistic estimates and to otherwise assure the quality of the services provided.

### BRIEF DESCRIPTION OF THE DRAWINGS

FIGS. 1-5 are block diagrams which illustrate the method of the present disclosure; and

FIG. 6 is a flow chart illustrating the operation of the present disclosure.

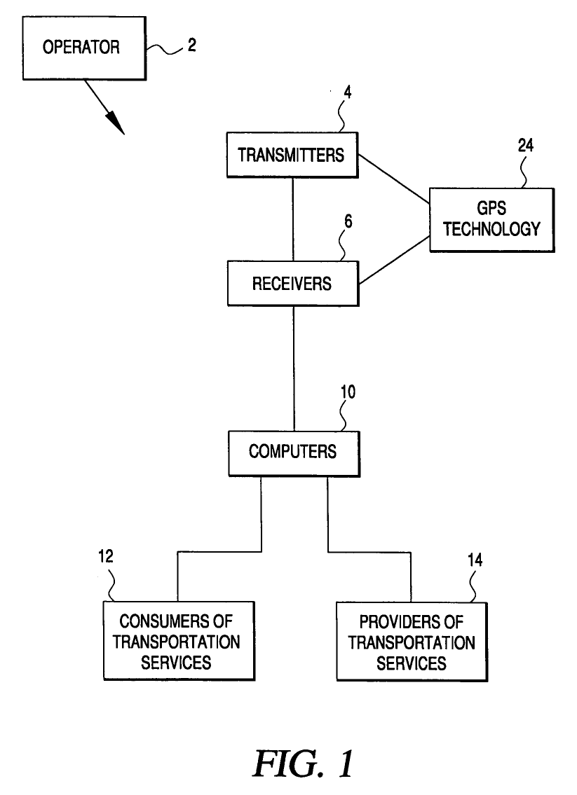

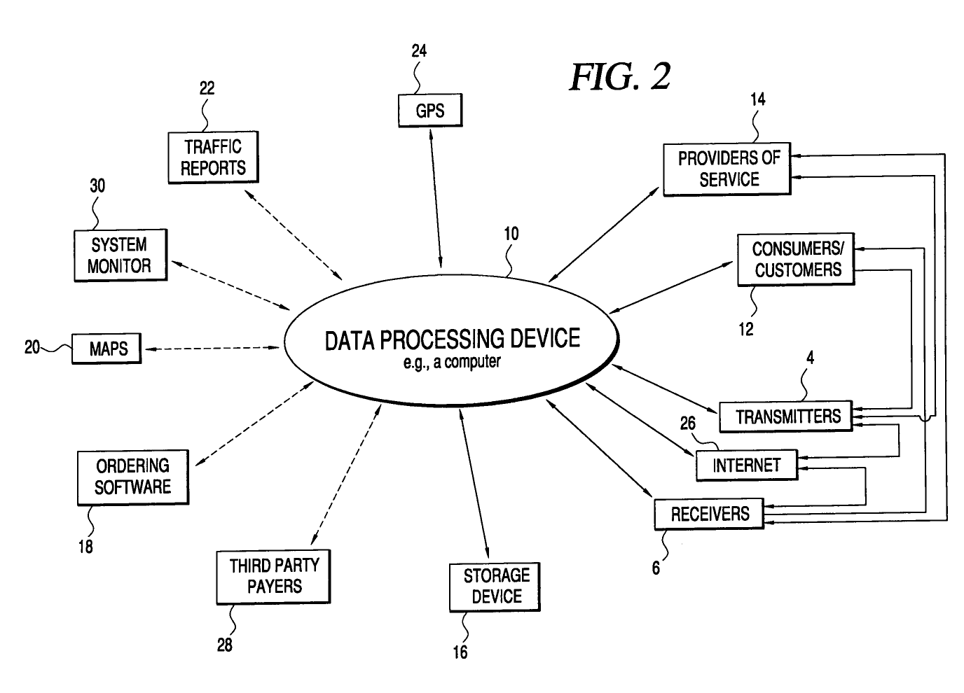

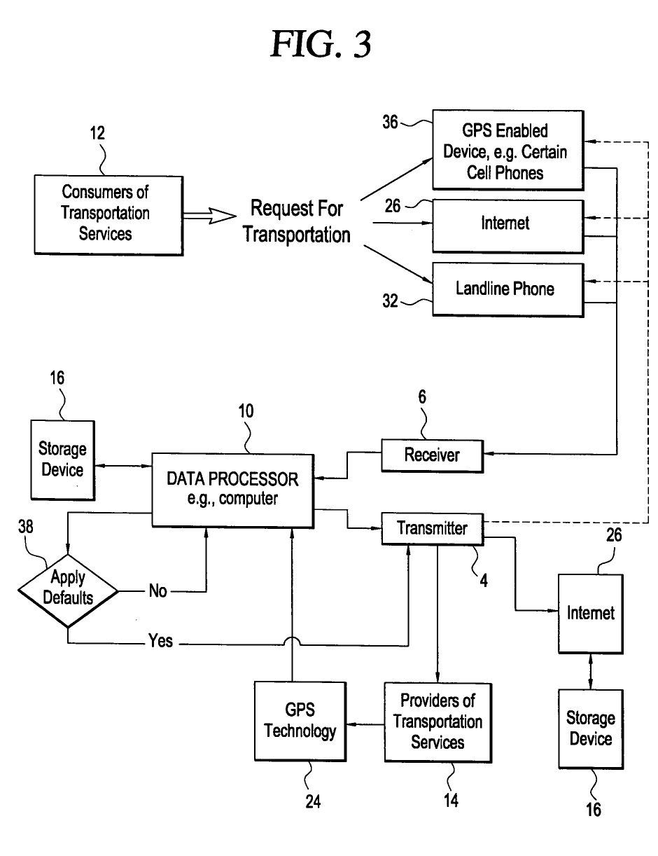

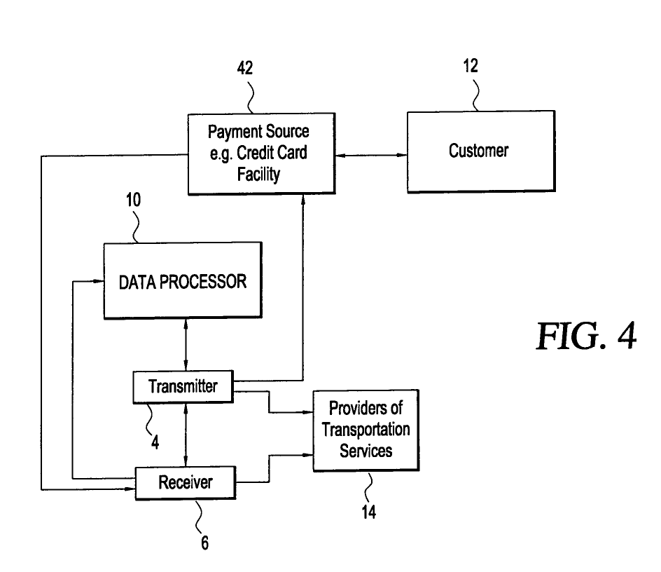

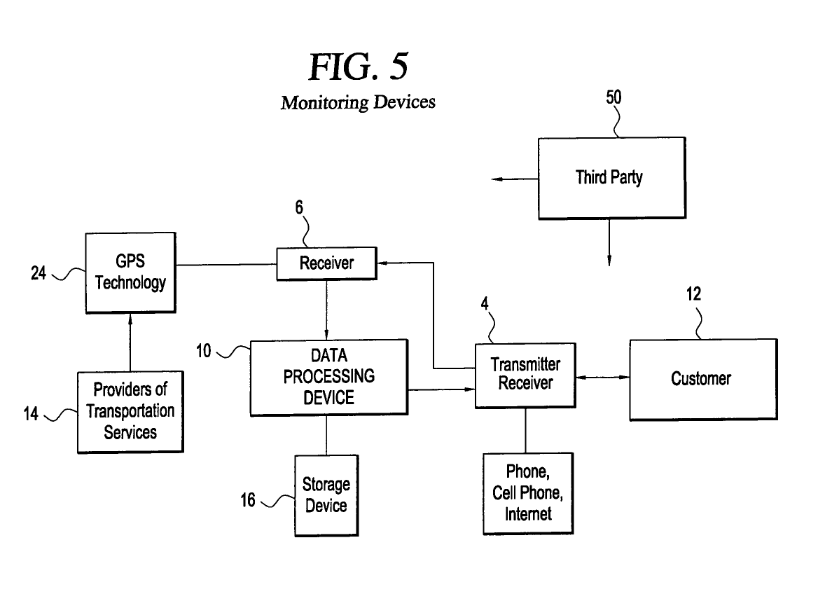

### DETAILED DESCRIPTION OF THE PREFERRED EMBODIMENT

The systems and methods of the present disclosure recognize the fact that most persons who order and provide transportation services want to do so in the most efficient, safe and flexible manner. The present disclosure can achieve one or more of these objectives.

For example, a consumer (customer) of transportation services (12) in a restaurant has finished a meal with friends and wants transportation. If the customer has a device equipped with Global Positioning System (“GPS”) (24) or a similar navigating system, the customer could simply hit at least one key or speak one command to a transmitter (4) which communicates her location, preferences and specifics, which may be based in whole or part by default criteria, to one op more receiver(s) (6) which can transmit the information to a data processing device (10) or in the alternative some or all of the preferences can be provided from a data storage device (16). The information is then compared and matched with that of providers of transportation services (14) who meet the criteria and have available transportation, and then match the customer with one or more particular modes of transportation (14) which match may include consideration of maps (20), traffic reports (22) and may use ordering software (18) to match the customer with available transportation and then the data processing device (10) may cause the consumer (12) to receive information concerning one or more specifics of the provider of transportation (14), including possibly the anticipated time of arrival and identity of the transportation and a designated meeting place. If the transportation is equipped with GPS (24) or a similar system the consumer (12) may be able to track the progress of the transportation through a system such as the internet (26). A system such as the internet (26) may enable the consumer to examine the available modes of transportation and arrange for services based on what the internet (26) or similar system states is available and, in this connection, may use default criteria from a storage device (16) to minimize manual inputting of data. The device could also provide the consumer (12) with mechanism for communicating with the driver, such as a telephone number for the driver or an email address that the consumer (12) could call to make any modifications (e.g. it is raining so I will be under the awning in front of the deli two doors down the street).

This provides the consumer (12) with convenience in that it may take her only a few seconds to order transportation from an identified provider. This is clearly superior to having, for example to hail a taxi on the street with no assurance when one will be available, or calling for a taxi which typically takes much more time and effort than the system described in the present disclosure. When the transportation (14) arrives the consumer (12) can provide the provider (14) with an identifier, such as a code that identifies her, or the code can be provided electronically by a device that she carries, which can be an identification assigned to the consumer (12) or one specific to the transaction. In either case the code could be associated with a system of payment which may involve third party payers (28) such as credit card companies that frees the consumer from carrying a means of payment. The transportation then takes the consumer to the consumer's destination (which can be a default destination). There may be no worry of overcharging if a system monitor (30) is in place that calculated the time and or distance based on measuring devices that are at least, in part, not within the control of the driver, such as GPS (24) and that can be in the control of or monitored by at least one person who is totally or generally independent of persons with a financial interest in the transaction. Such system (30) monitor can provide for incentive to provide quality services, which can include the imposition of penalties or payment of premiums.

This is also advantageous for the provider of the services (14). The provider has a high degree of assurance that the provider (14) will not be robbed and that the fare will be paid. Also the system and methods of the present disclosure should reduce cruising for fares which in turn reduces operator fatigue, wear and tear on modes of transportation, fuel consumption and related pollution.

The systems and methods of the present disclosure may include, among other features, at least one data storage device (16) capable or retaining data relevant to a consumer's (12) and preferences as well as other information such as maps (20), prioritizing/ordering software (18) and existing traffic patterns and volume. Such data can change over time (e.g., when a consumer (2) moves or when there is an accident). The data storage device (16) can minimizes the input of consumers (12) as well as increase the quality of the output, and therefore makes the use of the system more user-friendly.

Payment for use of the systems and methods of the present disclosure may come from a variety of sources including the consumer (12) and/or the persons providing the services (14) and/or the persons who provide services and/or equipment (e.g., the data processing device) that enable the system. The fees could be based on a variety of factors including a portion of the price paid for the services and/or on a flat rate, including a combination of the two.

A communication is initiated by the customer (12) who transmits a request for transportation. This request may be transmitted electronically over the internet (26) or electronically or though voice a mobile device such as a personal data assistant (“PDA”) or a cell phone (4). The processing of the request may incorporate a number of factors for example, estimated or guaranteed time of pickup/delivery, price of the service and type of service/vehicle and will generally include the location of the customer (12) by GPS (24) or otherwise determined by default from data in a storage device (16) or by the location from which the request is transmitted. For example, if a PDA (4) has GPS (24) incorporated within it, the process may retrieve data from the data storage device (16) for a transportation that is a Lincoln Town Car or comparable, to pick the consumer/customer up at, or near the location of the PDA, within 5 minutes. This criteria is transmitted to a receiver (6) and then to a data processing device (10) such as a computer, which compares it with data from providers of services (14), possible including the location of possible transportation (14), maps (20) and traffic reports (22) using GPS (24) which is used to determine the available vehicles/drivers, if any, that satisfy the criteria. This can be done for example by vehicles/drivers (14) providing information concerning their availability by the same type of communications (electronic such as internet, telephone and also transmitting their location, ideally by GPS or similar device). The data processing device (10) including a computer can either assign the pickup to one or more individual providers (14) immediately or give them a choice to accept or decline it within a certain time frame that can include a default mode (e.g., accept if not declined within 10 seconds). If the individual provider (14) declines the system then assigns the matter to another individual provider (14), and possibly another (14), and so on until one accepts it. The data processing device (10) can then assign or not assign a pickup location and/or the vehicle/driver (14) can be put directly in touch with the customer (12) to modify the pickup point.

Alternatively, if no vehicles are available at the given criteria, the data processing device (10) can transmit available alternatives in a standardized or customized order to a receiver (6) and/or the customer can provide different criteria. This can continue until the process arrives at a match or the process in abandoned by either party.

This would work similarly for other transportation services, including those furnished in connection with delivery services. For example, an appliance store which is a customer (12) may make contact using a transmitter (4) via the internet (26) or another medium which is received by a receiver (6) and transmitted to the data processor that it needs transportation services of a certain type to deliver one or more appliances. The store may have default criteria stored in a storage device (16) that it can modify, in whole or in part or not modify. As noted above once this information is transmitted to a data processing device it is matched with information from providers of these services (14) and the customer (12) can then be informed that there is a match or if not, the criteria upon which delivery services would be available, or can input new criteria itself. This can continue until there is a match or until one of the parties abandons the process.

In the alternative a customer (12) can provide criteria for transportation services it wishes to pay for, and providers of the service (14) can accept the criteria or not or provide alternative criteria.

A consumer or customer (12) may request transportation services via a landline phone (32). Such a request is received by a receiver (6) and processed by a data processor, such as a computer (10) and can capture the phone number of the customer making the call by the use of caller ID technology. The data processor may access a storage device (16) to determine the location of the customer (12) making the call using the customer's phone number. If the location is not in the storage device (16) or if the system wants to verify the location, it may use the internet (26) or other mediums that can provide locations of phone numbers, in the case of the internet (26) possibly by using search engines such as Google. The location of the customer (12) may also be verified with the customer (12) by voice prompts, e.g., “the address you would like transportation to arrive at begins with 44,” and/or by the use of text.

Once the location of the customer (12) is established, the system and method can determine whether or not, and the extent to which, to apply default criteria (38) in determining the search for transportation based on what is in the storage device (16) from previous contact with the customer (16). If such information is not available the data processor (12) use a transmitter (4) to contact the customer who (12) can enter or change customized criteria using the tone on a landline phone (32) or cell phone (36) or text messaging from a phone (32 and 36) or text messages or voice messages, which may include messages via the internet (26). This information may be received by a receiver (6) and transmitted to the data processor (10) and stored in a storage device (16).

Based on the location of the customer (16), the criteria for the selection of transportation then can identify the provider(s) of transportation (14), if any, that best fits the criteria of the customer (16). If there are none the customers (16) can be prompted to determine if they wish to change the criteria, for example by increasing the amount they are willing to pay. This process can go on until there is a match or until the customer abandons the process.

The process works in a similar manner if the internet (16) or a GPS device (36) is used except that in the case of a GPS enabled device (36) the location of the customer (16) will generally be determined based on use of GPS technology (24) such as the use of satellites.

The software used in the data processing device (10) can allocate transportation, from the perspective of the providers of transportation (14) on a variety of bases, including: on a group basis for related providers of transportation; based on the value of the customer (16) to the provider; or on an individual basis based on bids by providers. From the perspective of the customer (16) they can base what they are willing to pay on a static or a sliding scale that increases to the extent necessary to obtain transportation, and will typically be subject to a maximum.

The software can be used to calculate the cost, which using GPS technology (24), can be used to calculate the distance traveled, and where appropriate, the time taken to travel the distance. This can eliminate the need and cost of a meter in taxis and provide for a more objective basis for charges that is less subject to manipulation. The software can also adjust the cost based on the time and location of the destination and how easy or difficult it may be for the providers of transportation (14) to obtain their next customer (16) or to return to their garages.

Software can be used to provide payment for the services. Providers of transportation services (14) can provide bills that are transmitted to data processing devices (10) possibly through receivers (6) and the bills can be presented to payment sources such as credit card facilities (42) which can then pay for the services by transmitting funds to a receiver (6) which is then processed by the data processor (10), which can then use a transmitter (4) to transmit the finds to a receiver (6) in this case such as a bank, which can receive the funds on behalf of the customer (12).

This system and method can also provide for monitoring of the performance of provider of transportation. For example, the estimated arrival times provided to customer could be based on third party objective criteria, such as software originated, approved or monitored, in whole or part by persons who are in whole or part independent of the persons who use the system that is used to provide the anticipated arrival times in order to eliminate or reduce conflicts of interest that may otherwise be present and/or could be monitored to assess whether the times are realistic and accurate based on actual arrival times as provided by the GPS technology (24) and stored in a storage device (16). It also permits a customer (12) to monitor the progress of the transportation (12), in terms of its arrival time at the pickup point by using a transmitter/receiver to access the internet or by calling by phone in order to receive updated estimated arrival times without going through an operator. As noted above the system can identify customers (12) by their phone numbers or otherwise and therefore use software and a data processing device (10) to immediately provide them with the information it anticipates they may want, for example anticipated arrival times.

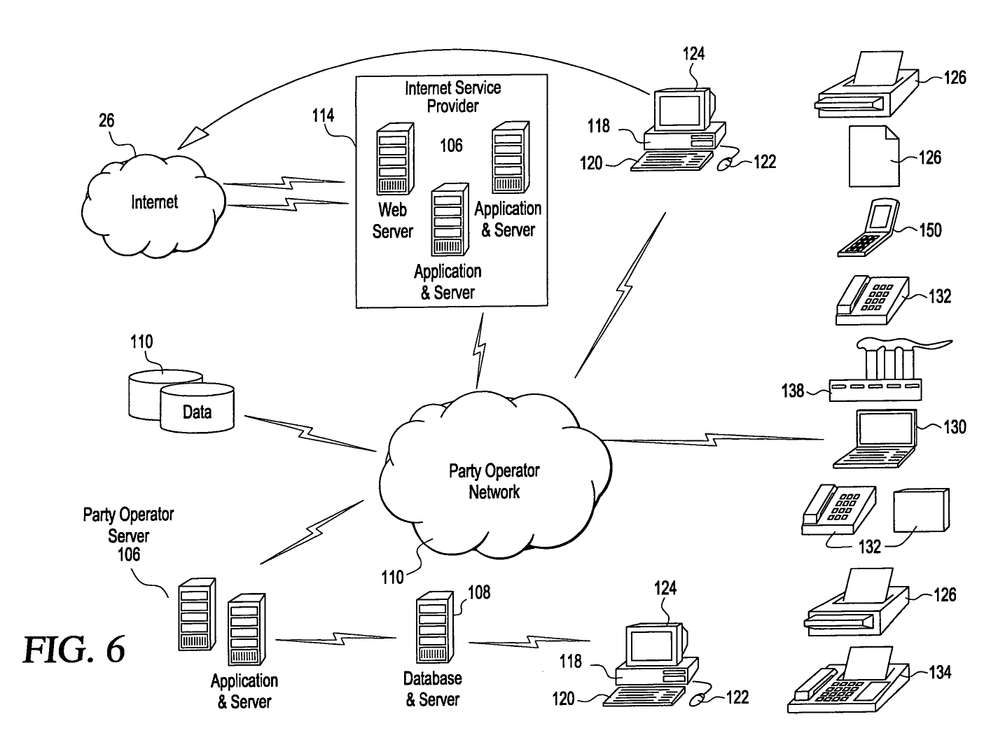

As is illustrated in FIG. 6, the provision of these products and services under the systems and methods of the present disclosure may require certain computer hardware, including but not limited to a mainframe computer or servers(s) (106) as a subset of data processing devices (10) for processing large volumes of data stored in a data storage unit (108) and a communications system, including but not limited to internet (26) phones (132) and cell phones (150) and other communications devices, as known to those skilled in the art. The stored data is taken from data provided by the customer (12) or third parties who may act on behalf of customers. A personal computer or workstation (118) having a hard drive or other storage device, an input device such as a keyboard 120 and mouse (122), and an output device such as a display 124 and printer 126 are operatively connected to the computer (118), as is known to those skilled in the art may be used to access the internet. In particular, computer programs used to implement the matching and pricing of the transportation services as well payment for such services loaded on the application servers (108) are used accessed by, or on behalf of the program operator (2) and are used to transmit under this system and method, in a tangible form to customers (12), as is known to those skilled in the art.

What is claimed is:

1. A system for automatically dispatching transportation services to persons, comprising:
a transmitter for transmitting on command, location, preferences and specifics and the like;
at least one receiver which receives the transmission of said transmitter;
a data processing device which receives a transmission from said at least one receiver, said data processing device compares the received information and matches it with that of a provider of transportation services stored in said data processing device; and
means for notifying the user of said transmitter.

2. The system as defined in claim 1, wherein:
said transmitter is equipped with a Global Positioning System.

3. The system as defined in claim 1, wherein:
the transmission is effected via the internet.
